(19) United States
(12) Patent Application Publication
(10) Pub. No.: US 2009/0010710 A1
(43) Pub. Date: Jan. 8, 2009

(54) Connecting device

(76) Inventor: Adrian Offenbroich, Dusseldorf (DE)

Correspondence Address: HARNESS, DICKEY & PIERCE, P.L.C., P.O. BOX 828, BLOOMFIELD HILLS, MI, 48303, US

(21) Appl. No.: 12/214,546

(22) Filed: Jun. 19, 2008

(30) Foreign Application Priority Data
Jun. 23, 2007 (EP) 07 012 342.7

(51) Int. Cl. F16D 1/00

(52) U.S. Cl. 403/404

(57) ABSTRACT

A connecting device for the detachable connection with a component, wherein the connecting device includes an anchor unit which is movable by means of a drive between a locking and a non-locking state and by which the connecting device can be fixed to the component. It is an object of the present invention to achieve an improvement and it is proposed by the invention that the drive includes a rotatable actuation member, by the rotation of which through an angle of less than approx 100°, especially approx 90°, the anchor unit can be brought from one state into the other.

### BACKGROUND OF THE INVENTION

1. Technical Field

The present invention relates to a connecting device for the detachable connection to a component, said connecting device including an anchor unit which is movable by a drive between a locking and a non-locking state and by which said connecting device can be fixed to the component.

2. Discussion

Devices of this generic type are used in the prior art as clamping joint systems for connections to be made in shelf systems, fair structures or similar connections between frame parts like posts, shelves and similar connection structures. To this end, individual elements such as posts, braces and the like are joined together with the aid of devices of this generic type, using a kind of rapid junction technique, so that a loadable structure may be achieved. A quick and simple handling of the connecting device is therefore desirable.

A device of this generic type is disclosed for instance in EP 1 234 985 B1, there referred to as a clamping joint system, wherein an anchor unit of the connecting device includes claw-like, movable anchor elements configured for being connected to the braces of a counter element such as a post. For this purpose, the anchor elements are inserted in an opening of the post. The fixation is effected by having claws which are formed on the ends of the anchor elements grip behind the rim of the opening, thereby fixing the connecting device to the post. The drive for driving the anchor elements is comprised of a transmission translating a rotational movement of an actuation member into a translational movement of the anchor elements.

The actuation member itself protrudes from the device and is formed by a bolt which is supported for rotation and which includes on a protruding face a contour allowing to apply a tool like a screw driver, a hex driver or the like in a form-fit fashion, so that a rotary movement may be performed.

Although devices of this generic type are tried and tested in the practice, it turned out to be a disadvantage in practical use that a relatively large rotary movement is required for the fixation of the connecting device respectively its separation. Precisely during manual operations this is disadvantageous from the ergonomic aspect.

### SUMMARY OF THE INVENTION

The present invention is therefore based on achieving an improvement in this respect.

In the preferred embodiment, the invention proposes that the drive includes a rotatable actuation member, wherein by the rotation of this actuation member through an angle smaller than approx 100 degrees, in particular approximately 90 degrees, the anchor unit can be transferred from one state to the other.

Thus, a reduction can be obtained of the ergonomically adverse rotary movement from a large angle to a small angle and, in this way, not only a faster mounting but also an increased reliability can be achieved. Precisely when working under time pressure, complicated movements are frequently not fully completed by the personnel, so that with prior art connecting devices a fixation is not always guaranteed, because the respective state which complies with the requirements is not fully obtained by the anchor elements. This may cause safety problems. The invention avoids these problems because the desired state of the anchor unit can be already securely achieved by a rotary movement which is clearly smaller than it is usual in prior art. The actuation member may be preferably formed as a bolt which is provided with bulges or recesses, for applying a suitable driving tool. The actuation member may be for instance in the form of a hexagon or it may also include a hexagon socket, a Torx recess or the like. In this way, the drive may easily be manually operated. The small rotation that is required for changing the states here turns out as an advantage for the manual operability.

It is further proposed for the anchor unit to include in the region of a coupling with the actuation member a recess into which the actuation member protrudes. It should be noted, that the recess may of course be formed also by an opening the actuation member projects through. It is possible in this way to achieve simple driving of the anchor unit by the actuation member. Of course, the recess may be formed also by a cavity into which the actuation member protrudes. The coupling region is the region where the actuation member becomes mechanically operatively connected to the anchor unit, i.e. where an operation of the actuation member results in a movement of the anchor unit.

According to a further development, the actuation member includes in the coupling region with the anchor unit a substantially chamfered, circular cross section. This design allows in a simple way to obtain the desired operation of the anchor unit at only a small angle of rotation of the actuation member. Additional transmission elements by which the desired movement of the anchor unit can be obtained are avoidable. Accordingly, a reliably operating connecting device may be obtained with only a few components.

It is further proposed that the coupling region on the recess side is formed to be substantially linear. In this way, a desired drive can be obtained alone by a corresponding design of the actuation member. The manufacture can be simplified all in all, because the anchor unit may be specifically designed for its anchoring properties. The actuation member may include for instance bulges or recesses in the circumferential area in the coupling region with the anchor unit, in order to be able to achieve the desired effect of movement of the anchor unit. Preferably, a corresponding slideway can be provided circumferentially on the actuation member. For achieving a device which is as durable and wear-resistant as possible, discontinuities in the coupling region of the actuation member as well as the anchor unit shall be avoided as far as possible.

Accordingly, it may be provided for instance that the chamfered part is performed with lead-in lips or rounded-off portions, for avoiding or reducing wear on discontinuous positions on one side and for achieving a largely uniform driving torque on the other side.

In a further development it is provided that guide means for guiding an anchor element of the anchor unit are provided in a substantially translational direction and transversely to the translational direction at least in parts. It can be achieved in this way that the anchor elements of the anchor unit can be inserted in an opening of the post in a non-locking position and in the course of moving the anchor elements into the locking position by a movement transversely to the translational direction overlap a rim of the opening of the post by their claws. In this manner, a simple and reliable, ultra-strong connection can be obtained. The guide means may be formed for instance by grooves, rails and the like which are adapted for cooperating with counter means such as profiles, guide pins and the like.

According to a further development, the guide means include a bulge which engages in a guide slideway. The bulge may be formed for instance by bulging the material of the anchor element, by a guide pin which is arranged on the anchor element, or the like. The guide slideway may be formed groove-like or also as an opening, while the bulge preferably permanently engages in the guide slideway. The guide slideway may be formed by a slant, by a curvature or also by a combination of such shapes. The curvature may be formed for instance by a section of a circle or of an ellipse. Incidentally, the curvature may have any other desired form. The guide slideway may also or additionally be formed by one or more different slants. A substantially banana-like guide slideway turned out particularly advantageous. It is possible thereby to obtain not only a desired drive of the anchor elements but additionally also an ergonomically favorable torque characteristic at the actuation member.

According to a further proposal of the invention, the anchor unit is prestressed in the direction of the non-locking state. This allows the anchor unit to be permanently coupled to the actuation member in the coupling region. Moreover, any damaged connecting device may be easily replaced by removing the actuation member, so that a disassembly is in any case possible with simple means. Hence, ease of operation can be further improved.

According to a further proposal, the connecting device includes a lock guard. With this lock guard it can be achieved that the connecting device is maintained in the locking state, independently of an operation of the actuation member. This is advantageous especially in complex structures, in which individual connecting devices would possibly remain in a non-locking state as a result of a faulty operation, thus causing a safety problem. According to a further advantage, the invention proposes that the lock guard includes a display unit. In this way it is possible to directly check the connecting devices in an existing structure for their condition, for instance by visual inspection or the like. The safety can be further improved.

In a further advantageous embodiment it is proposed that the lock guard is operable by an actuator. Accordingly, it may be provided for instance that the lock guard is adapted for remote control. In this way it is possible to achieve a securing of the connecting devices in the locking state from a central position for instance. Operability and safety can be further improved.

Moreover, the anchor element may include a bulge in a connecting region with the component. In the connecting region the anchor element is connectible to the component. The anchor element may be formed for instance in a claw-shape in the connecting region, and the claws may include one or several bulges such as spikes, vaults or the like. By this bulge a smoother transition can be obtained both during tightening and loosening. Further, by a notch formed on one inner side of the component, the danger that the anchor unit slips off can be avoided or at least reduced.

Further advantages and features will become apparent from the following description. Similar components are identified by similar reference numbers. Further, concerning similar features and functions, reference is made to the description of the embodiment in FIG. 1. The drawings are schematic drawings and merely serve to explain the following embodiment.

### BRIEF DESCRIPTION OF THE DRAWINGS

FIG. 1 is a top view of a clamping device according to the invention, in a non-locked state;

FIG. 2 is a section in the longitudinal direction through the clamping device according to FIG. 1, along line II-II;

FIG. 3 is an anchor element in a plan view, from the inventive device according to FIG. 1;

FIG. 4 is the anchor element according to FIG. 3, in a side view;

FIG. 5 is a clamping element by which a guide pin is fixed to the anchor element;

FIG. 6 is a schematic perspective view of a drive for the connecting device according to FIG. 1;

FIG. 7 is a top view of the drive according to FIG. 6; and

FIG. 8 is a side view of the drive according to FIG. 6.

### DESCRIPTION OF THE PREFERRED EMBODIMENTS

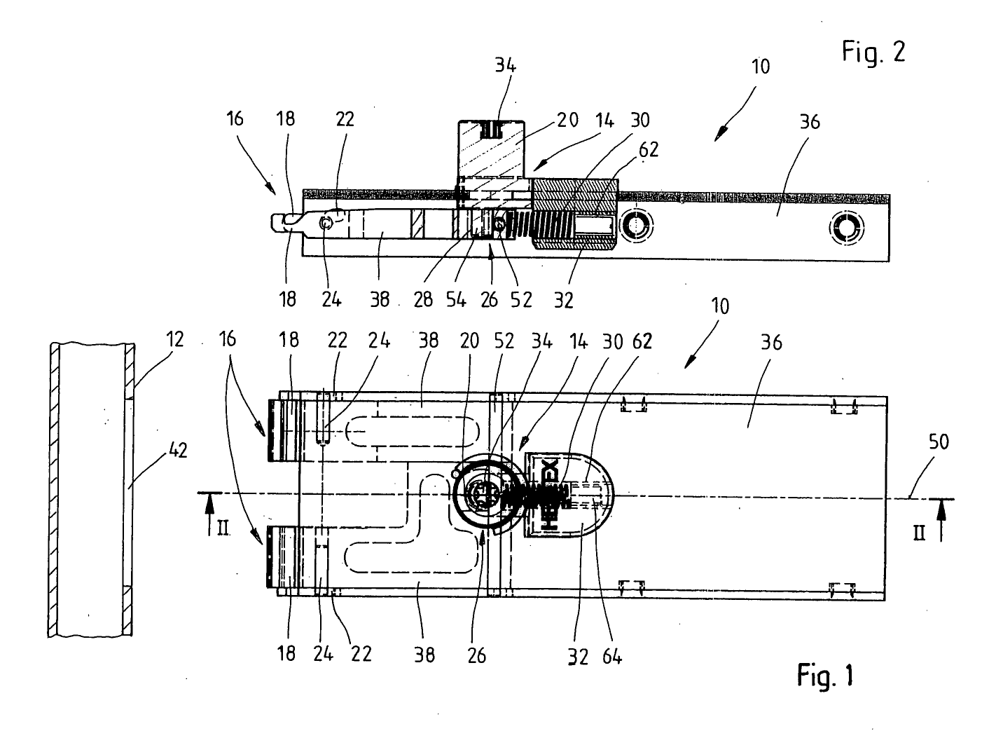

FIG. 1 illustrates in a top view a connecting device according to the present invention, hereinafter referred to as a clamping device 10. The clamping device 10 includes a housing 36 in which all the essential units are compactly arranged. Illustrated as protruding to the right are lock bar claws 18 of an anchor unit 16, which lock bar claws represent end portions of anchor elements 38 of the anchor unit 16. The anchor elements 38 of the anchor unit 16 are arranged for displacement in the longitudinal direction of the housing 36. In the illustration as shown, the anchor unit 16 assumes its non-locking state. In this state, the clamping connector 10 can be fixed to a post 12 in which the lock bar claws 18 are inserted in an opening 42 of the post 12. By operating an actuation member 20 of a drive 14 the anchor elements 38 and along with them the lock bar claws 18 are axially pulled-in in the direction of the housing 36. During this, they are simultaneously moved transversely to their axial movement direction, so that the lock bar claws 18 in the locking state grip behind a rim portion (not illustrated) of the opening 42, thus fixing the clamping connector 10 to the post 12.

For detaching the clamping connector 10 from the post 12 the above operation is performed in the reverse order, wherein the anchor elements 38 are axially displaced in the longitudinal direction of the housing 36 towards the post 12 while simultaneously moving transversely in a way such that the same become positioned in substantially one plane (see also FIG. 2). In this state the clamping connector 10 can be detached from the post 12.

FIG. 2 shows the clamping connector 10 according to FIG. 1 in a sectional view along line II-II. It can be seen in this illustration that the lock bar claws 18 of the anchor elements 38 in the non-locking state as shown in FIG. 2 are substantially in one plane and protrude from the housing 36 to the left. For achieving a good operation, the opening 42 of the post 12 is formed in a slot-like fashion so that the protruding lock bar claws 18 which are arranged in the position as shown in FIG. 2 can be inserted in the opening 42. When moving the clamping connector 10 into the locking state the anchor elements 38 are not only pulled towards the housing 36 but, as may described by way of FIG. 2, one of the lock bar claws 18 is moved upwardly and the other one downwardly so that the lock bar claws 18 can grip behind the rim of the opening 42.

To be able to perform this movement, guide pins 24 are arranged on the anchor elements 38, which guide pins are guided in banana-like guide slideways 22 of side walls of the housing 36. The guide pins 24 as well as the slideways 22 have the effect that with an axial displacement of the anchor elements 38 the lock bar claws 18 at the same time perform an upward or downward movement transversely to the axial displacement. The banana-like curvature of the guide slideway 22 is configured in such a way that a torque which is as uniform as possible is achieved on the actuation side. In the present case, the banana shape is designed in such a way that one third of the operation distance is substantially linear, while the remaining operation distance is curved.

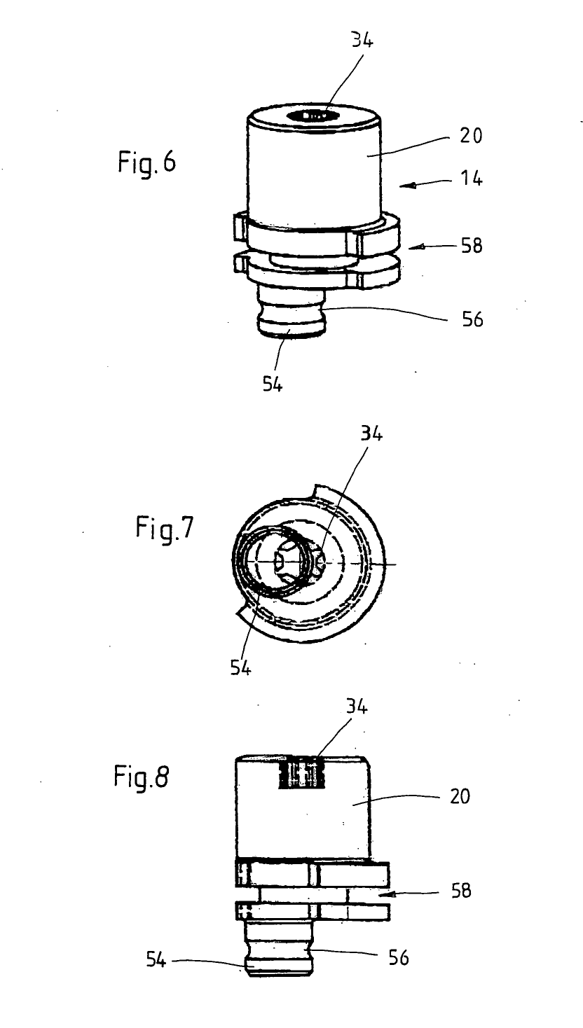

On an axis 50 of the housing 36 which also represents the longitudinal axis of the housing, the actuation member 20 is arranged which in the present case is devised as a bolt and forms the substantially centrally arranged drive 14 (FIGS. 6 to 8). The drive 14 is illustrated in the FIGS. 6 to 8. In this embodiment the drive 14 merely comprises a single actuation member 20. On the operation side the actuation element 20 includes a Torx recess 34 in which a corresponding wrench can be applied for operating the actuation element 20 manually by rotation. The drive 14 includes on the housing side a supporting portion 58, by which it is supported for rotation on the housing 36. Further, an eccentrically arranged pin 54 which is formed substantially as a circular cylinder protrudes into the housing 36. The pin 54 has a continuous groove 56 (FIGS. 6, 8).

As it can be seen from FIG. 2, the pin 54 protrudes into an opening 28 formed by the anchor elements 38. Oppositely to the lock bar claws 18 on the other end in the region of the opening 28 a connecting pin 52 is arranged to which the two anchor elements 38 are coupled as regards mobility. For this purpose, the connecting pin 52 is not only connected to the anchor elements 38 but is additionally supported for displacement respectively in an elongated hole (not further described) arranged parallel to the axis 50 in a housing wall of the housing 36, by the end portions thereof which are not further described. The connecting pin abuts on the groove of the pin 54. This is achieved by the fact that a spiral spring 30 which is supported against an abutment supported by the housing 36 pushes against a spring support 40 of the anchor elements 38. In the present case, for setting the prestressing of the spring, a set screw 64 is provided which is arranged in a threaded bore 62. Thereby the connecting pin 52 is permanently pressed against the pin 54, whereby a coupling region 26 is established. The abutment 32 includes a set screw (not further shown) as an adjustable prestressing means by which the prestressing of the spiral spring 30 can be adjusted according to the needs. Of course, also other suitable means may be provided for changing the prestressing of the spiral spring 30.

From FIG. 2 it can be seen that as a result of rotating the actuation member 20 by an angle of <90° the anchor elements 28 are already pulled into the housing 36 of the clamping connector 10 against the prestressing by the spiral spring 30, through the connecting pin 52 as well as the pin 54. When the actuation member 20 is rotated back, the coupling region 26 remains established because of the prestressing of the spring, and the connecting pin moves the clamping elements 38 towards the exit of the housing 36 as a result of the prestressing of the spring. This movement takes place until the maximum possible movement in this direction is reached which is predetermined by the cutting edge 56 of the pin 54. Although this cannot be seen in the figures, a marking is arranged adjacent to the Torx recess 34 on the actuation member 20, by which marking a locked condition of the clamping device 10 is indicated. In the present case this marking is provided as an arrow which in the opened condition points to a symbol “open” which is embossed adjacent to the actuation member 20 on the housing 36. In the locked condition the arrow points to a further symbol corresponding to this condition, for instance “closed”. Of course, also the symbols of locks or the like may be provided for indicating the respective condition.

FIG. 3 is an enlarged illustration of one of the anchor elements 38. Here a part of the opening 28 can be seen, while the other part of the opening 28 is formed by the second anchor element 38. Further, the region 26 can be seen in which the anchor element 38 includes a bulge (not further described) which is provided for receiving the connecting pin 52. In the region of the lock bar claw 18 a further bulge is provided which serves to receive the guide pin 24. On the lock bar claw 18 spikes 60 are arranged.

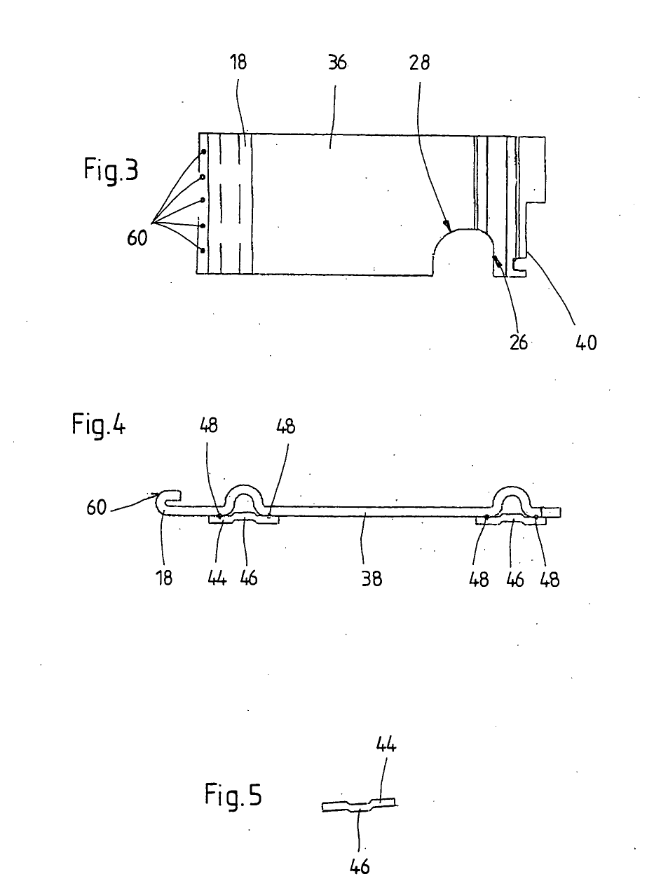

FIG. 4 shows a lateral view of the anchor element 38 according to FIG. 3. In the left part, the lock bar 18 can be seen which is joined by the bulge for the guide pin 24. The bulge is closed by a clamping element 44 which is fixed to the anchor element by means of welded spots 48. To provide for an appropriate fixation of the guide pin 24 in the recess of the anchor element 38, the clamping element 44 includes a bulge 46 (FIG. 5). The bulge is thereby reduced of its inner diameter to such an extent that the guide pin 24 is fixed in the bulge. A similar fixation is provided also for the connecting element 52 (FIG. 4).

The embodiment illustrated in the figures merely serves for explaining the invention and is not in any way limiting.

What is claimed is:

1. A connecting device for detachable connection to a component, said connecting device (10) comprising an anchor unit (16) which is movable by a drive (14) between a locking and a non-locking state and by which the connecting device (10) can be fixed to the component (12), and wherein the drive (14) includes a rotatable actuation member (20), wherein by rotating said actuation member through an angle of less than approx 100° the anchor unit (16) can be brought into a different state.

2. The connecting device according to claim 1, wherein the region (26) of a coupling with the actuation member (20) the anchor unit (16) includes a recess (28) into which the actuation member (20) protrudes.

3. The connecting device according to claim 1 wherein the coupling region (26) with the anchor unit (16) the actuation member (20) includes a substantially chamfered, circular cross section.

4. The connecting device according to claim 1 wherein said coupling region (26) is formed substantially linearly on the recess side.

5. The connecting device according to claim 1 wherein guide means (22, 24) for guiding an anchor element (38) of the anchor unit (16) are provided in a translational direction and transversely to the translational direction at least in parts.

6. The connecting device according to claim 5 wherein the guide means (22, 24) include a bulge (24) which engages in a guide slideway (22).

7. The connecting device according to claim 6, wherein the guide slideway (22) is formed substantially arcuate.

8. The connecting device according to claim 1 wherein the anchor unit (16) is prestressed in the direction of the non-locking state.

9. The connecting device according to claim 1 further comprising a lock guard.

10. The connecting device according to claim 9 wherein the lock guard includes a display unit.

11. The connecting device according to claim 9 wherein the lock guard is operable by means of an actuator.

12. The connecting device according to claim 1 wherein the anchor element (38) includes a bulge (60) in a connecting region with the component (12).
